(19) United States
(12) Patent Application Publication
(10) Pub. No.: US 2026/0264475 A1
(43) Pub. Date: Sep. 10, 2026

(54) VEHICULAR HEAT PUMP SYSTEM

(71) Applicant: Hyundai Wia Corporation, Changwon-si (KR)

(72) Inventors: Ji Yong SHIN, Uiwang-si (KR); Hwan O. SHIN, Uiwang-si (KR)

(73) Assignee: HYUNDAI WIA Corporation, Changwon-si (KR)

(21) Appl. No.: 19/559,040

(22) Filed: Mar. 6, 2026

(30) Foreign Application Priority Data
Mar. 10, 2025 (KR) 10-2025-0030562

(51) Int. Cl. B60H 1/00

(52) U.S. Cl. CPC B60H 1/00921; B60H 1/00278; B60H 2001/00307; B60H 2001/00928; B60H 2001/00949

(57) ABSTRACT

Disclosed is a vehicular heat pump system. The vehicular heat pump system includes a compressor configured to compress refrigerant, a first air-conditioning apparatus including an indoor heat exchanger and an evaporator, the indoor heat exchanger and the evaporator being configured to enable heat exchange of refrigerant discharged from the compressor, a second air-conditioning apparatus including a dual-purpose heat exchanger configured to enable heat exchange of refrigerant delivered from the first air-conditioning apparatus, and an outdoor heat exchanger configured to enable heat exchange between refrigerant and outdoor air. The second air-conditioning apparatus is configured to perform both heating and cooling functions using the dual-purpose heat exchanger.

### CROSS-REFERENCE TO THE RELATED APPLICATION

The present application claims priority to and the benefit of Korean Patent Application No. 10-2025-0030562, filed on Mar. 10, 2025, in the Korean Intellectual Property Office, the entire disclosure of which is incorporated herein by reference.

### BACKGROUND

### 1. Field

The present disclosure relates to a vehicular heat pump system, and more particularly, to a vehicular heat pump system including two air-conditioning apparatuses.

### 2. Description of the Related Art

A general air-conditioning apparatus includes a cooling system for cooling an interior of a vehicle and a heating system for heating the interior of the vehicle. The cooling system operates such that refrigerant flowing through an evaporator of a refrigerant cycle absorbs heat from air flowing over an outer surface of the evaporator, thereby generating cold air and cooling the interior of the vehicle. The heating system operates such that high-temperature refrigerant discharged from a compressor is introduced into a heat exchanger and is condensed while exchanging heat with surrounding air, thereby generating warm air and heating the interior of the vehicle.

Meanwhile, in a case of an electric vehicle, a heat pump system is applied to minimize heating energy consumption in order to increase driving range. The heat pump system may selectively perform cooling and heating by switching a flow direction of refrigerant using a single refrigerant cycle.

### SUMMARY

The present disclosure has been made in view of the above-described issues, and an aspect of the present disclosure is to provide a heat pump system having a novel structure, in which a dual-purpose heat exchanger capable of performing both cooling and heating is applied to an air-conditioning apparatus, so that both a heating function and a cooling function are implemented without additionally mounting an indoor condenser for heating in a vehicular heat pump system including two air-conditioning apparatuses.

A vehicular heat pump system according to an embodiment of the present disclosure for accomplishing the above aspect includes a compressor configured to compress refrigerant, a first air-conditioning apparatus including an indoor heat exchanger and an evaporator, the indoor heat exchanger and the evaporator being configured to enable heat exchange of refrigerant discharged from the compressor, a second air-conditioning apparatus including a dual-purpose heat exchanger configured to enable heat exchange of refrigerant delivered from the first air-conditioning apparatus, and an outdoor heat exchanger configured to enable heat exchange between refrigerant and outdoor air. The second air-conditioning apparatus is configured to perform both heating and cooling functions using the dual-purpose heat exchanger.

The dual-purpose heat exchanger may be configured to evaporate refrigerant in a cooling mode and to condense refrigerant in a heating mode.

The first air-conditioning apparatus may further include a first air-conditioning case accommodating the indoor heat exchanger and the evaporator, and the second air-conditioning apparatus may be separately provided from the first air-conditioning apparatus and may further include a second air-conditioning case accommodating the dual-purpose heat exchanger. The compressor, the first air-conditioning apparatus, and the outdoor heat exchanger may be connected to one another via a refrigerant circulation line, and the second air-conditioning apparatus may be connected to the vehicular heat pump system via at least one refrigerant line.

The vehicular heat pump system may further include a first expansion valve mounted on a refrigerant circulation line extending from an outlet of the outdoor heat exchanger to the evaporator of the first air-conditioning apparatus at a location upstream of the evaporator, and the first expansion valve may be configured to expand refrigerant flowing toward the first air-conditioning apparatus.

The vehicular heat pump system may further include a directional control valve mounted upstream of the first expansion valve and a first refrigerant line extending from the directional control valve to the dual-purpose heat exchanger of the second air-conditioning apparatus.

The vehicular heat pump system may further include a second refrigerant line branching from a predetermined branch point of a refrigerant circulation line extending from the compressor to the indoor heat exchanger and merging with the first refrigerant line and a first three-way valve provided at the branch point.

The first three-way valve may include an inlet connected to the compressor and two outlets connected in parallel to the indoor heat exchanger of the first air-conditioning apparatus and the dual-purpose heat exchanger of the second air-conditioning apparatus. The first three-way valve may switch a flow direction of refrigerant having passed through the compressor toward the indoor heat exchanger of the first air-conditioning apparatus or the dual-purpose heat exchanger of the second air-conditioning apparatus.

Refrigerant having passed through the first three-way valve may flow to the indoor heat exchanger along the refrigerant circulation line, may flow to the dual-purpose heat exchanger of the second air-conditioning apparatus via the second refrigerant line and the first refrigerant line, or may flow to both the indoor heat exchanger and the dual-purpose heat exchanger.

The vehicular heat pump system may further include a second expansion valve mounted on a refrigerant circulation line connected to an inlet of the outdoor heat exchanger, and the second expansion valve may be configured to expand or pass refrigerant to be supplied to the outdoor heat exchanger.

The vehicular heat pump system may further include a third refrigerant line extending from the dual-purpose heat exchanger and merging with a refrigerant circulation line between the indoor heat exchanger and the outdoor heat exchanger and a second three-way valve mounted on the third refrigerant line. The second three-way valve may be configured to switch a flow direction of refrigerant flowing along the third refrigerant line.

The vehicular heat pump system may further include a chiller configured to receive refrigerant flowing along the refrigerant circulation line and to allow the refrigerant to exchange heat with a battery or an electric part.

The second three-way valve may allow refrigerant having passed through the dual-purpose heat exchanger to flow to a refrigerant circulation line between the indoor heat exchanger and the outdoor heat exchanger so as to be mixed with refrigerant having passed through the indoor heat exchanger or to flow to a refrigerant circulation line connecting the chiller to the compressor so as to be introduced into the compressor.

The vehicular heat pump system may further include a third expansion valve mounted on the first refrigerant line.

In the heating mode, opening/closing of the first three-way valve may be controlled to allow refrigerant having passed through the compressor to flow to the indoor heat exchanger of the first air-conditioning apparatus. High-temperature and high-pressure refrigerant discharged from the compressor may be condensed through heat exchange with indoor air of a vehicle while passing through the indoor heat exchanger of the first air-conditioning apparatus, and the condensed refrigerant may be expanded in the second expansion valve, may flow to the outdoor heat exchanger or to the chiller, may absorb heat in the outdoor heat exchanger or the chiller, and may flow to the compressor via an accumulator.

In the heating mode, opening/closing of the first three-way valve may be controlled to allow refrigerant having passed through the compressor to flow to the dual-purpose heat exchanger of the second air-conditioning apparatus. High-temperature and high-pressure refrigerant discharged from the compressor may be condensed through heat exchange with indoor air of the vehicle while passing through the dual-purpose heat exchanger of the second air-conditioning apparatus, and the condensed refrigerant may be expanded in the second expansion valve via the second three-way valve, may flow to the outdoor heat exchanger or to the chiller, may absorb heat in the outdoor heat exchanger or the chiller, and may flow to the compressor via the accumulator.

In the heating mode, opening/closing of the first three-way valve may be controlled to allow refrigerant having passed through the compressor to flow to both the indoor heat exchanger of the first air-conditioning apparatus and the dual-purpose heat exchanger of the second air-conditioning apparatus. High-temperature and high-pressure refrigerant discharged from the compressor may diverge from the first three-way valve to the indoor heat exchanger of the first air-conditioning apparatus and to the dual-purpose heat exchanger of the second air-conditioning apparatus so as to be condensed through heat exchange with indoor air of the vehicle. The refrigerant condensed in the dual-purpose heat exchanger may flow into the refrigerant circulation line via the second three-way valve, and may be mixed with refrigerant flowing out of the indoor heat exchanger. The refrigerant condensed in the indoor heat exchanger and the refrigerant condensed in the dual-purpose heat exchanger may be expanded in the second expansion valve, may flow to the outdoor heat exchanger or to the chiller, may absorb heat in the outdoor heat exchanger or the chiller, and may flow to the compressor via the accumulator.

In the cooling mode, opening/closing of the first three-way valve may be controlled to allow refrigerant having passed through the compressor to flow to the indoor heat exchanger of the first air-conditioning apparatus, and opening/closing of the directional control valve may be controlled to allow refrigerant having passed through the outdoor heat exchanger to flow to the evaporator of the first air-conditioning apparatus.

High-temperature and high-pressure refrigerant discharged from the compressor may pass through the indoor heat exchanger of the first air-conditioning apparatus and the second expansion valve via the first three-way valve, and may flow to the outdoor heat exchanger. The high-temperature and high-pressure refrigerant may be cooled and condensed in the outdoor heat exchanger and may flow to the chiller, or may be introduced into the evaporator of the first air-conditioning apparatus via the directional control valve and may be evaporated in the evaporator. Refrigerant reaching the chiller and refrigerant discharged from the evaporator may be mixed and may flow to the compressor via the accumulator.

In the cooling mode, opening/closing of the first three-way valve may be controlled to allow refrigerant having passed through the compressor to flow to the indoor heat exchanger of the first air-conditioning apparatus, and opening/closing of the directional control valve may be controlled to allow refrigerant having passed through the outdoor heat exchanger to flow to the dual-purpose heat exchanger of the second air-conditioning apparatus.

High-temperature and high-pressure refrigerant discharged from the compressor may pass through the indoor heat exchanger of the first air-conditioning apparatus and the second expansion valve via the first three-way valve, and may flow to the outdoor heat exchanger. The high-temperature and high-pressure refrigerant may be cooled and condensed in the outdoor heat exchanger and may flow to the chiller, or may flow to the second air-conditioning apparatus via the directional control valve and may be evaporated in the dual-purpose heat exchanger. The evaporated low-temperature refrigerant may pass through the second three-way valve. The second three-way valve may allow the low-temperature refrigerant to flow to a refrigerant circulation line connecting the chiller to the compressor, and the low-temperature refrigerant reaching the refrigerant circulation line and refrigerant flowing out of the chiller may be mixed and introduced into the compressor.

The refrigerant reaching the chiller may be used to cool a battery or an electric part, and refrigerant flowing from the chiller toward the compressor and refrigerant discharged from the dual-purpose heat exchanger may be mixed and may flow to the compressor via the accumulator.

In the cooling mode, opening/closing of the first three-way valve may be controlled to allow refrigerant having passed through the compressor to flow to the indoor heat exchanger of the first air-conditioning apparatus, and opening/closing of the directional control valve may be controlled to allow refrigerant having passed through the outdoor heat exchanger to flow to both the evaporator of the first air-conditioning apparatus and the dual-purpose heat exchanger of the second air-conditioning apparatus.

High-temperature and high-pressure refrigerant discharged from the compressor may pass through the indoor heat exchanger of the first air-conditioning apparatus and the second expansion valve via the first three-way valve, and may flow to the outdoor heat exchanger. The high-temperature and high-pressure refrigerant may be cooled and condensed in the outdoor heat exchanger and may flow to the chiller, or may flow to both the first air-conditioning apparatus and the second air-conditioning apparatus via the directional control valve. The refrigerant flowing toward the first air-conditioning apparatus may be throttled while passing through the expansion valve, and may be evaporated in the evaporator. The refrigerant flowing toward the second air-conditioning apparatus may pass through the first refrigerant line, may be throttled while passing through the expansion valve, and may be evaporated in the dual-purpose heat exchanger. The evaporated low-temperature refrigerant may pass through the second three-way valve. The second three-way valve may allow the low-temperature refrigerant to flow to a refrigerant circulation line connecting the chiller to the compressor, and the low-temperature refrigerant reaching the refrigerant circulation line and refrigerant flowing out of the chiller may be mixed and introduced into the compressor.

The refrigerant reaching the chiller may be used to cool a battery or an electric part, and refrigerant flowing from the chiller toward the compressor and refrigerant discharged from the dual-purpose heat exchanger may be mixed and may flow to the compressor via the accumulator.

### BRIEF DESCRIPTION OF THE DRAWINGS

The accompanying drawings, which are incorporated in this specification, illustrate exemplary embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a block diagram showing a configuration of a vehicular heat pump system according to an embodiment of the present disclosure;

FIG. 2 is a block diagram showing the configuration of the vehicular heat pump system shown in FIG. 1, in which a refrigerant circulation line and a plurality of refrigerant lines are distinguished;

FIG. 3 is a block diagram showing a case in which a heating mode is implemented using only a first air-conditioning apparatus;

FIG. 4 is a block diagram showing a case in which the heating mode is implemented using only a second air-conditioning apparatus;

FIG. 5 is a block diagram showing a case in which the heating mode is implemented using both the first air-conditioning apparatus and the second air-conditioning apparatus;

FIG. 6 is a block diagram showing a case in which a cooling mode is implemented using only the first air-conditioning apparatus;

FIG. 7 is a block diagram showing a case in which the cooling mode is implemented using only the second air-conditioning apparatus; and

FIG. 8 is a block diagram showing a case in which the cooling mode is implemented using both the first air-conditioning apparatus and the second air-conditioning apparatus.

### DETAILED DESCRIPTION OF EXEMPLARY EMBODIMENTS

Hereinafter, exemplary embodiments of the present disclosure will be described in detail with reference to the accompanying drawings. Embodiments of the present disclosure are provided to more fully illustrate the disclosure to a person having ordinary skill in the art, and the following embodiments may be modified in various other forms, and the scope of the disclosure is not limited to the following embodiments. The embodiments are provided to make the disclosure more faithful and complete and to completely convey the idea of the disclosure fully to those skilled in the art.

In the following drawings, the thickness or size of each layer is exaggerated for convenience and clarity of description, and same reference numerals in the drawings refer to the same elements. As used herein, the term “and/or” includes any one of the enumerated items and any combination of one or more thereof. As used herein, the term “connected” refers not only to direct connection between members A and B but also to indirect connection between members A and B with member C interposed therebetween. The terms used in the specification are intended to describe specific embodiments and are not intended to limit the disclosure. As used herein, singular forms may include plural forms, unless the context clearly indicates otherwise. As used herein, the terms “comprise” (or “include”) and/or “comprising” (or “including”) are intended to specify the presence of stated figures, numbers, steps, operations, members, elements, and/or groups thereof and do not exclude the presence or addition of one or more other figures, numbers, steps, operations, members, elements, and/or groups thereof.

While terms such as “first” and “second” are used herein to describe various members, parts, regions, layers, and/or portions, the members, the parts, the regions, the layers, and/or the portions are not to be limited by the terms. The terms are used only to distinguish one member, one part, one region, one layer, or one portion from another member, another part, another region, another layer, or another portion. Thus, a first member, a first part, a first region, a first layer, or a first portion hereinafter described may refer to a second member, a second part, a second region, a second layer, or a second portion without departing from the teachings of the disclosure.

Terms related to space, such as “beneath,” “below,” “lower,” “above,” and “upper,” may be utilized to facilitate understanding of one element or feature shown in the drawings as different from another element or feature. The terms related to space are intended to facilitate understanding of the disclosure in various states of process or use and are not intended to limit the disclosure. For example, if an element or feature in a figure is inverted, an element or feature described as “beneath” or “below” becomes “above” or “upper.” Thus, “beneath” is a concept that encompasses “above” or “below.”

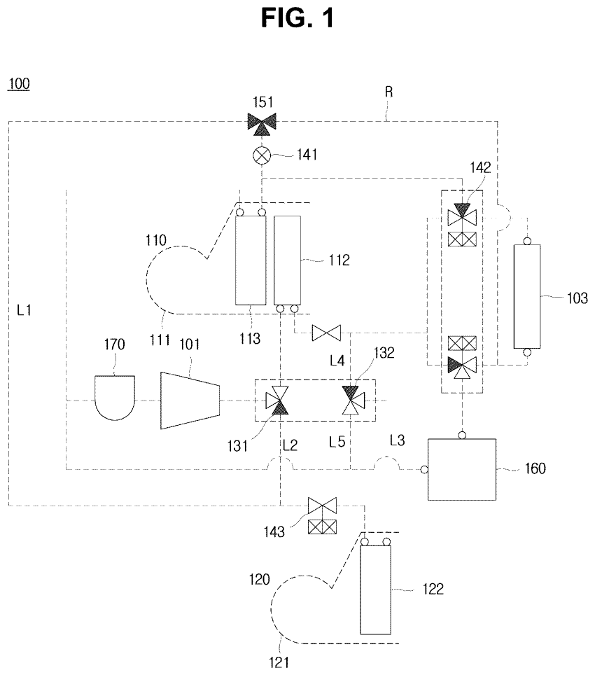

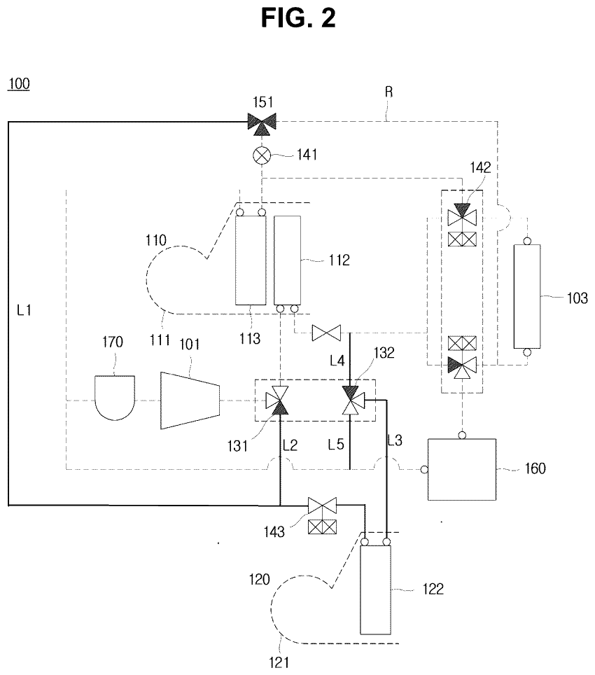

FIG. 1 is a block diagram showing a configuration of a vehicular heat pump system according to an embodiment of the present disclosure, and FIG. 2 is a block diagram showing the configuration of the vehicular heat pump system shown in FIG. 1, in which a refrigerant circulation line and a plurality of refrigerant lines are distinguished. Hereinafter, a vehicular heat pump system according to an embodiment of the present disclosure will be described. The following description will be given with reference to FIGS. 1 and 2.

A vehicular heat pump system 100 according to an embodiment of the present disclosure includes a compressor 101, a first air-conditioning apparatus 110, a second air-conditioning apparatus 120, and an outdoor heat exchanger 103.

The compressor 101, the first air-conditioning apparatus 110, and the outdoor heat exchanger 103 are connected to one another via a refrigerant circulation line R, and the second air-conditioning apparatus 120 is connected to the vehicular heat pump system 100 via one or more refrigerant lines L1, L2, L3, and L4. In the present disclosure, in order to conceptually distinguish refrigerant lines used for cooling and heating by the second air-conditioning apparatus 120 from the refrigerant circulation line R used for cooling and heating by the first air-conditioning apparatus 110, the refrigerant lines are referred to as first to fourth refrigerant lines L1 to L4. In FIG. 2, for distinction, the refrigerant circulation line R is illustrated by dashed lines, and the refrigerant lines L1, L2, L3, and L4 are illustrated by solid lines.

The compressor 101 draws in refrigerant, compresses the refrigerant, and discharges the refrigerant in a gaseous state at high temperature and high pressure. The compressor 101 is connected to the first air-conditioning apparatus 110 via the refrigerant circulation line R, and an indoor heat exchanger 112 and an evaporator 113 are mounted in a first air-conditioning case 111 of the first air-conditioning apparatus 110 and are connected to the compressor 101. An accumulator 170 is mounted on the refrigerant circulation line R upstream of the compressor 101 in order to prevent introduction of liquid refrigerant into the compressor 101 during heating.

The indoor heat exchanger 112 is an indoor condenser and enables heat exchange of refrigerant discharged from the compressor 101. That is, the indoor heat exchanger 112 allows the high-temperature and high-pressure refrigerant to exchange heat with indoor air, thereby condensing the refrigerant. During this process, heat is released to the air, and the warm air is supplied to the interior of the vehicle to heat the interior.

Similar to the indoor heat exchanger 112, the evaporator 113 is mounted in the first air-conditioning case 111. In a cooling cycle, the evaporator 113 allows refrigerant supplied from the compressor 101 to exchange heat with surrounding air in the air-conditioning case, thereby cooling the air.

The outdoor heat exchanger 103 is mounted outside the first air-conditioning apparatus 110 and enables heat exchange between the refrigerant and outdoor air. That is, the outdoor heat exchanger 103 cools and condenses the high-temperature and high-pressure refrigerant or allows expanded refrigerant to absorb heat from outdoor air.

The heat pump system according to the embodiment of the present disclosure includes a second air-conditioning apparatus 120 separately from the first air-conditioning apparatus 110. The second air-conditioning apparatus 120 includes a dual-purpose heat exchanger 122 disposed in a second air-conditioning case 121 and configured to enable heat exchange of the refrigerant delivered from the first air-conditioning apparatus 110. The dual-purpose heat exchanger 122 according to the present disclosure operates to evaporate the refrigerant in a cooling mode and to condense the refrigerant in a heating mode. That is, the dual-purpose heat exchanger 122 performs both a cooling function and a heating function according to an air-conditioning mode. The dual-purpose heat exchanger 122 functions as the evaporator 113 in the cooling mode, and functions as an indoor condenser in the heating mode. An operation mechanism related thereto will be described in detail later.

The vehicular heat pump system 100 according to the embodiment of the present disclosure further includes a chiller 160 configured to receive refrigerant flowing along the refrigerant circulation line R and to allow the refrigerant to exchange heat with a battery or an electric part. The chiller 160 allows the refrigerant introduced into the refrigerant circulation line R to exchange heat with coolant received from a coolant line (not shown) to which coolant is supplied from an electric part or a coolant line (not shown) to which coolant is supplied from a battery module, thereby adjusting a temperature of the coolant. In the cooling state, the chiller 160 allows low-pressure refrigerant to exchange heat with a battery or an electric part of the vehicle, thereby expanding the refrigerant. The chiller 160 may be a water-cooled heat exchanger configured to receive coolant.

On the refrigerant circulation line R extending from an outlet of the outdoor heat exchanger 103 to the evaporator 113 of the first air-conditioning apparatus 110, a first expansion valve 141 is mounted upstream of the evaporator 113. The first expansion valve 141 is configured to expand refrigerant flowing to the first air-conditioning apparatus 110 in the cooling mode.

A directional control valve 151 is mounted upstream of the first expansion valve 141. The refrigerant circulation line R between the outdoor heat exchanger 103 and the evaporator 113 of the first air-conditioning apparatus 110 includes a branch line extending to allow a portion of the refrigerant to flow to the second air-conditioning apparatus 120, which will be described later. To this end, the directional control valve 151 is mounted at the branch point of the refrigerant circulation line R, and the first refrigerant line L1 branches from the directional control valve 151 and extends to the dual-purpose heat exchanger 122 of the second air-conditioning apparatus 120.

The compressor 101 and the first air-conditioning apparatus 110 are connected to each other via the refrigerant circulation line R and receive the refrigerant. The second refrigerant line L2 branches from a predetermined point (branch point) of the refrigerant circulation line R extending from the compressor 101 to the indoor heat exchanger 112, and merges with the above-described first refrigerant line L1 upstream of the dual-purpose heat exchanger 122. Due to the branch structure of the second refrigerant line L2, the high-temperature and high-pressure refrigerant discharged from the compressor 101 may flow to the dual-purpose heat exchanger 122 of the second air-conditioning apparatus 120. In this case, a first three-way valve 131 is mounted at the branch point of the refrigerant circulation line R. An inlet of the first three-way valve 131 is connected to the compressor 101, one of two outlets thereof is connected to the indoor heat exchanger 112 of the first air-conditioning apparatus 110, and the other of the two outlets thereof is connected to the dual-purpose heat exchanger 122 of the second air-conditioning apparatus 120. Accordingly, the first three-way valve 131 is configured to switch a flow direction of the refrigerant so that the refrigerant that has passed through the compressor 101 flows to the indoor heat exchanger 112 of the first air-conditioning apparatus 110 or to the dual-purpose heat exchanger 122 of the second air-conditioning apparatus 120.

In the present disclosure, opening/closing of the first three-way valve 131 is controlled such that the refrigerant that has passed through the first three-way valve 131 flows to the indoor heat exchanger 112 along the refrigerant circulation line R, flows to the dual-purpose heat exchanger 122 of the second air-conditioning apparatus 120 via the second refrigerant line L2 and the first refrigerant line L1, or flows to both the indoor heat exchanger 112 and the dual-purpose heat exchanger 122.

A second expansion valve 142 is mounted on the refrigerant circulation line R extending to an inlet of the outdoor heat exchanger 103, that is, the refrigerant circulation line R connecting the indoor heat exchanger 112 to the outdoor heat exchanger 103. The second expansion valve 142 is configured to expand or pass the refrigerant to be supplied to the outdoor heat exchanger 103.

The third refrigerant line L3 extends from the dual-purpose heat exchanger 122 and merges with the refrigerant circulation line R between the indoor heat exchanger 112 and the outdoor heat exchanger 103. As shown, the third refrigerant line L3 merges with the refrigerant circulation line R upstream of the second expansion valve 142. In this case, a second three-way valve 132 is mounted on the third refrigerant line L3 in order to implement the cooling mode and the heating mode by switching a flow direction of the refrigerant.

An inlet of the second three-way valve 132 is connected to the dual-purpose heat exchanger 122 via the third refrigerant line L3, one of two outlets thereof is connected to the refrigerant circulation line R between the indoor heat exchanger 112 and the outdoor heat exchanger 103 via the fourth refrigerant line L4, and the other of the two outlets thereof is connected to the refrigerant circulation line R between the chiller 160 and the compressor 101 via a fifth refrigerant line L5. Accordingly, opening/closing of the second three-way valve 132 is controlled to allow the refrigerant that has passed through the dual-purpose heat exchanger 122 to flow into the refrigerant circulation line R between the indoor heat exchanger 112 and the outdoor heat exchanger 103 and then to be delivered to the outdoor heat exchanger 103 or to allow the refrigerant to flow into the refrigerant circulation line R between the chiller 160 and the compressor 101 and then to be delivered to the compressor 101. In this way, a flow direction of the refrigerant that has passed through the dual-purpose heat exchanger 122 may be switched by controlling opening/closing of the second three-way valve 132.

A third expansion valve (two-way expansion valve) 143 is mounted on the first refrigerant line L1. When a cooling mode using the second air-conditioning apparatus 120 is performed, the first refrigerant line L1 functions to allow the refrigerant to flow to the dual-purpose heat exchanger 122 of the second air-conditioning apparatus 120, and the third expansion valve 143 functions to throttle the refrigerant so that the dual-purpose heat exchanger 122 performs a cooling function.

Hereinafter, a mechanism by which an air-conditioning mode is performed in the vehicular heat pump system 100 according to the embodiment of the present disclosure will be described.

### [Embodiment 1] Heating Mode Using Only First Air-Conditioning Apparatus 110

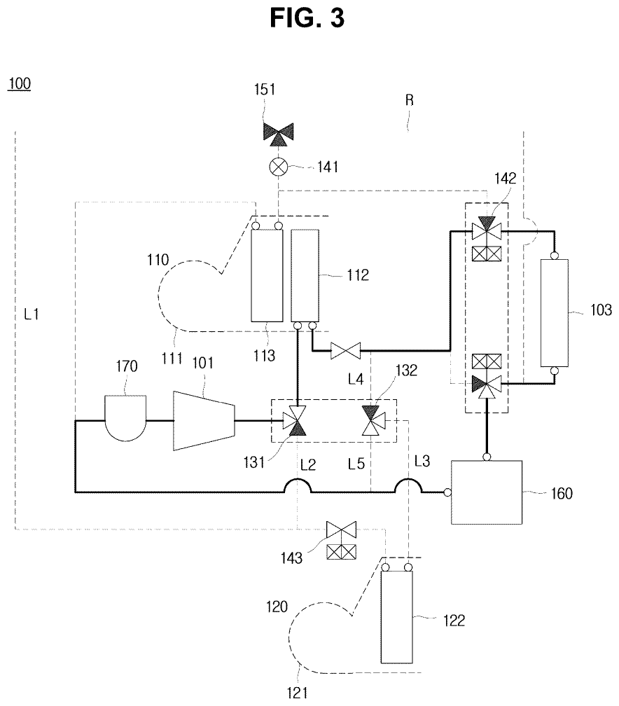

FIG. 3 is a block diagram showing a case in which the heating mode is implemented using only the first air-conditioning apparatus. Hereinafter, embodiment 1 will be described with reference to FIG. 3.

In order to implement the heating mode according to embodiment 1 using only the first air-conditioning apparatus 110, opening/closing of the first three-way valve 131 is controlled such that the refrigerant that has passed through the compressor 101 flows to the indoor heat exchanger 112 of the first air-conditioning apparatus 110.

In detail, the refrigerant is discharged from the compressor 101 at high temperature and high pressure. A flow direction of the high-temperature and high-pressure refrigerant is determined by the first three-way valve 131 such that the refrigerant flows to the first air-conditioning apparatus 110. Thereafter, the refrigerant exchanges heat with indoor air of the vehicle while passing through the indoor heat exchanger 112 of the first air-conditioning apparatus 110, and the indoor air of the vehicle is heated through heat exchange, thereby implementing operation of the heating system. Thereafter, the refrigerant passing through the indoor heat exchanger 112 is condensed, and the condensed refrigerant flows to the second expansion valve 142 along the refrigerant circulation line R extending to the outdoor heat exchanger 103 and is expanded. The refrigerant that has undergone expansion and is in a low-pressure state flows to the outdoor heat exchanger 103 or to the chiller 160. The refrigerant absorbs heat from outside while passing through the outdoor heat exchanger 103 or the chiller 160, and the refrigerant having absorbed heat passes through the accumulator 170 and is then introduced into the compressor 101.

### [Embodiment 2] Heating Mode Using Only Second Air-Conditioning Apparatus 120

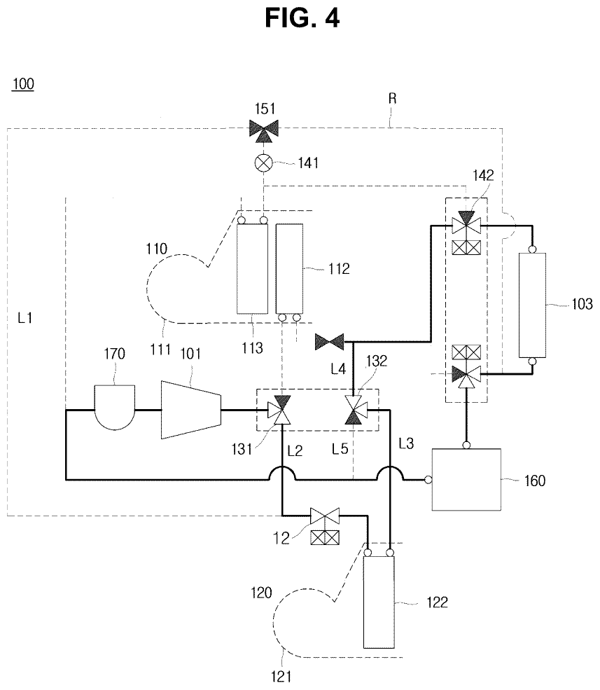

FIG. 4 is a block diagram showing a case in which the heating mode is implemented using only the second air-conditioning apparatus. Hereinafter, embodiment 2 will be described with reference to FIG. 4.

In order to implement the heating mode according to embodiment 2 using only the second air-conditioning apparatus 120, opening/closing of the first three-way valve 131 is controlled such that the refrigerant that has passed through the compressor 101 flows to the dual-purpose heat exchanger 122 of the second air-conditioning apparatus 120. In this case, opening/closing of the second three-way valve 132 is controlled such that the refrigerant that has passed through the dual-purpose heat exchanger 122 flows into the refrigerant circulation line R between the indoor heat exchanger 112 and the outdoor heat exchanger 103.

A flow direction of the high-temperature and high-pressure refrigerant discharged from the compressor 101 is determined by the first three-way valve 131 such that the refrigerant flows to the second air-conditioning apparatus 120. Thereafter, the refrigerant exchanges heat with indoor air of the vehicle while passing through the dual-purpose heat exchanger 122, and the indoor air of the vehicle is heated through heat exchange, thereby implementing operation of the heating system. Thereafter, the refrigerant passing through the dual-purpose heat exchanger 122 is condensed, and the condensed refrigerant passes through the second three-way valve 132 along the third refrigerant line L3 and is then introduced into the refrigerant circulation line R between the indoor heat exchanger 112 and the outdoor heat exchanger 103. Thereafter, the refrigerant flows to the second expansion valve 142 along the refrigerant circulation line R and is expanded. The refrigerant that has undergone expansion and is in a low-pressure state flows to the outdoor heat exchanger 103 or to the chiller 160. The refrigerant absorbs heat from outside while passing through the outdoor heat exchanger 103 or the chiller 160, and the refrigerant having absorbed heat passes through the accumulator 170 and is then introduced into the compressor 101.

### [Embodiment 3] Heating Mode Using Both First Air-Conditioning Apparatus 110 and Second Air-Conditioning Apparatus 120

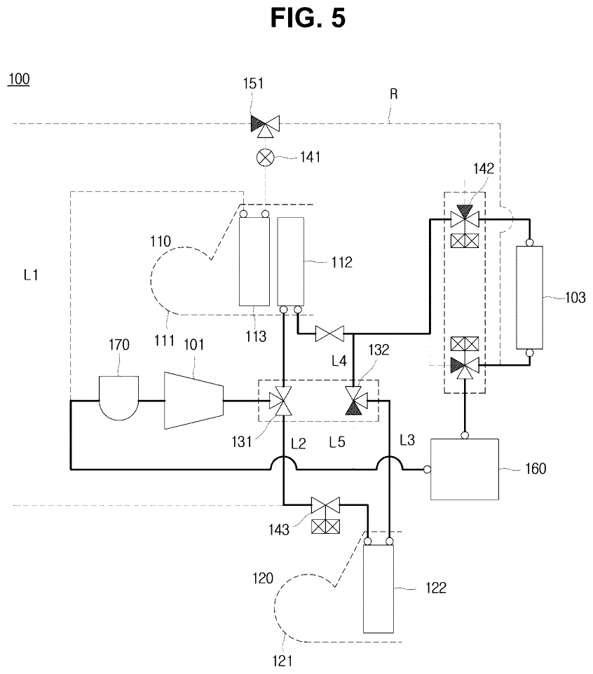

FIG. 5 is a block diagram showing a case in which the heating mode is implemented using both the first air-conditioning apparatus and the second air-conditioning apparatus. Hereinafter, embodiment 3 will be described with reference to FIG. 5.

In order to implement the heating mode according to embodiment 3 using both the first air-conditioning apparatus 110 and the second air-conditioning apparatus 120, opening/closing of the first three-way valve 131 is controlled such that the refrigerant that has passed through the compressor 101 flows to both the indoor heat exchanger 112 of the first air-conditioning apparatus 110 and the dual-purpose heat exchanger 122 of the second air-conditioning apparatus 120. In this case, opening/closing of the second three-way valve 132 is controlled such that the refrigerant that has passed through the dual-purpose heat exchanger 122 flows into the refrigerant circulation line R between the indoor heat exchanger 112 and the outdoor heat exchanger 103.

The high-temperature and high-pressure refrigerant discharged from the compressor 101 diverges to both the two outlets of the first three-way valve 131 and then flows to the indoor heat exchanger 112 of the first air-conditioning apparatus 110 and to the dual-purpose heat exchanger 122 of the second air-conditioning apparatus 120. In the first air-conditioning apparatus 110, the refrigerant exchanges heat with indoor air of the vehicle while passing through the indoor heat exchanger 112, and the indoor air of the vehicle is heated through heat exchange, thereby implementing operation of the heating system. Similarly, in the second air-conditioning apparatus 120, the refrigerant exchanges heat with the indoor air of the vehicle while passing through the dual-purpose heat exchanger 122, and the indoor air of the vehicle is heated through heat exchange, thereby implementing operation of the heating system. The refrigerant condensed while passing through the indoor heat exchanger 112 flows to the second expansion valve 142 through the refrigerant circulation line R. In the second air-conditioning apparatus 120, the refrigerant is condensed while passing through the dual-purpose heat exchanger 122, and the condensed refrigerant passes through the second three-way valve 132 along the third refrigerant line L3 and is then introduced into the refrigerant circulation line R between the indoor heat exchanger 112 and the outdoor heat exchanger 103. Accordingly, the condensed refrigerant is mixed with the refrigerant flowing out of the indoor heat exchanger 112. Thereafter, the mixed refrigerant flows to the second expansion valve 142 along the refrigerant circulation line R and is expanded. The refrigerant that has undergone expansion and is in a low-pressure state flows to the outdoor heat exchanger 103 or to the chiller 160. The refrigerant absorbs heat from outside while passing through the outdoor heat exchanger 103 or the chiller 160, and the refrigerant having absorbed heat passes through the accumulator 170 and is then introduced into the compressor 101.

According to embodiments 1 to 3 described above, the first air-conditioning apparatus 110 or the second air-conditioning apparatus 120 may perform the heating function independently, or the first air-conditioning apparatus 110 and the second air-conditioning apparatus 120 may perform the heating function simultaneously.

### [Embodiment 4] Cooling Mode Using Only First Air-Conditioning Apparatus 110

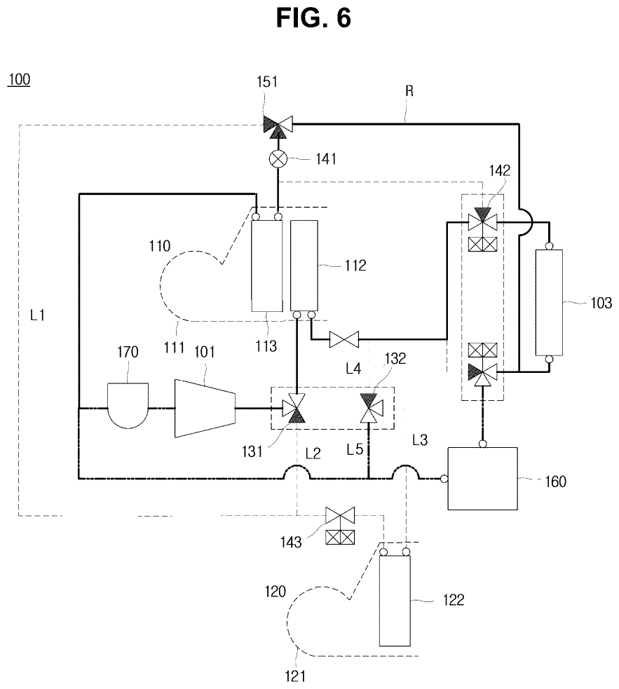

FIG. 6 is a block diagram showing a case in which the cooling mode is implemented using only the first air-conditioning apparatus. Hereinafter, embodiment 4 will be described with reference to FIG. 6.

In order to implement the cooling mode according to embodiment 4 using only the first air-conditioning apparatus 110, opening/closing of the first three-way valve 131 is controlled such that the refrigerant that has passed through the compressor 101 flows to the indoor heat exchanger 112 of the first air-conditioning apparatus 110. In addition, opening/closing of the directional control valve 151 is controlled such that the refrigerant that has passed through the outdoor heat exchanger 103 flows to the evaporator 113 of the first air-conditioning apparatus 110.

A flow direction of the high-temperature and high-pressure refrigerant discharged from the compressor 101 is determined by the first three-way valve 131 such that the refrigerant flows to the first air-conditioning apparatus 110. Thereafter, the refrigerant passes through the indoor heat exchanger 112 of the first air-conditioning apparatus 110 and the second expansion valve 142. In this case, the second three-way valve 132 mounted on the third refrigerant line L3 is controlled such that the outlet thereof connected to the refrigerant circulation line R is closed, thereby preventing backflow of the refrigerant. Thereafter, the refrigerant flows to the outdoor heat exchanger 103 or to the chiller 160.

The high-temperature and high-pressure refrigerant reaching the outdoor heat exchanger 103 is condensed and cooled in the outdoor heat exchanger 103. The condensed and cooled refrigerant flows to the evaporator 113 of the first air-conditioning apparatus 110 through the refrigerant circulation line R and is evaporated in the evaporator 113. In this case, the refrigerant passes through the directional control valve 151 and the first expansion valve 141 at a location upstream of the evaporator 113.

In addition, the refrigerant may flow to the chiller 160 in order to cool the battery. The refrigerant evaporated while passing through the chiller 160 flows to the upstream side of the accumulator 170 through the refrigerant circulation line R and is then introduced into the compressor 101. In this case, the refrigerant that has passed through the chiller 160 is mixed with the refrigerant discharged from the evaporator 113 of the first air-conditioning apparatus 110. The mixed refrigerant flows to the compressor 101 via the accumulator 170.

### [Embodiment 5] Cooling Mode Using Only Second Air-Conditioning Apparatus 120

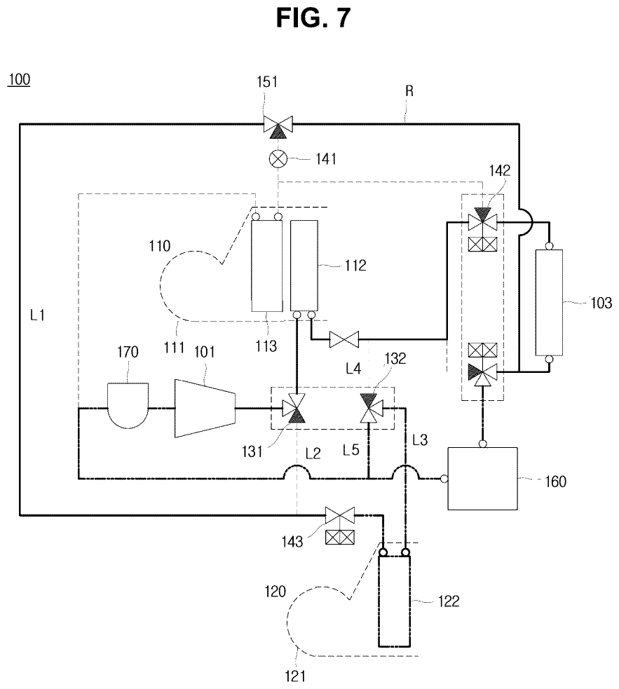

FIG. 7 is a block diagram showing a case in which the cooling mode is implemented using only the second air-conditioning apparatus. Hereinafter, embodiment 5 will be described with reference to FIG. 7.

In order to implement the cooling mode according to embodiment 5 using only the second air-conditioning apparatus 120, opening/closing of the first three-way valve 131 is controlled such that the refrigerant that has passed through the compressor 101 flows to the indoor heat exchanger 112 of the first air-conditioning apparatus 110. In addition, opening/closing of the directional control valve 151 is controlled such that the refrigerant that has passed through the outdoor heat exchanger 103 flows to the dual-purpose heat exchanger 122 of the second air-conditioning apparatus 120.

A flow direction of the high-temperature and high-pressure refrigerant discharged from the compressor 101 is determined by the first three-way valve 131 such that the refrigerant flows to the first air-conditioning apparatus 110. Thereafter, the refrigerant passes through the indoor heat exchanger 112 of the first air-conditioning apparatus 110 and the second expansion valve 142. In this case, the second three-way valve 132 mounted on the third refrigerant line L3 is controlled such that the outlet thereof connected to the refrigerant circulation line R is closed, thereby preventing backflow of the refrigerant. Thereafter, the refrigerant flows to the outdoor heat exchanger 103 or to the chiller 160. The high-temperature and high-pressure refrigerant reaching the outdoor heat exchanger 103 is condensed and cooled in the outdoor heat exchanger 103. The condensed and cooled refrigerant flows along the refrigerant circulation line R and passes through the directional control valve 151. In this case, opening/closing of the directional control valve 151 is controlled such that the refrigerant flows to the dual-purpose heat exchanger 122 of the second air-conditioning apparatus 120. Accordingly, the refrigerant bypasses the first air-conditioning apparatus 110 and flows to the second air-conditioning apparatus 120 along the first refrigerant line L1. During this process, the refrigerant is throttled while passing through the third expansion valve 143. Thereafter, the refrigerant flows to the second air-conditioning apparatus 120 and is then evaporated in the dual-purpose heat exchanger 122.

The low-temperature refrigerant cooled while passing through the dual-purpose heat exchanger 122 passes through the second three-way valve 132. As described above, the outlet of the second three-way valve 132 that is connected to the refrigerant circulation line R is in a closed state. Accordingly, the second three-way valve 132 allows the refrigerant to flow to the refrigerant circulation line R connecting the chiller 160 to the compressor 101. The refrigerant reaching the refrigerant circulation line R is mixed with the refrigerant flowing out of the chiller 160, and the mixed refrigerant flows to the compressor 101.

The refrigerant reaching the chiller 160 is used to cool the battery or the electric part of the vehicle. The refrigerant flowing toward the compressor 101 from the chiller 160 is mixed with the refrigerant discharged from the dual-purpose heat exchanger 122 of the second air-conditioning apparatus 120. The mixed refrigerant flows to the compressor 101 via the accumulator 170.

### [Embodiment 6] Cooling Mode Using Both First Air-Conditioning Apparatus 110 and Second Air-Conditioning Apparatus 120

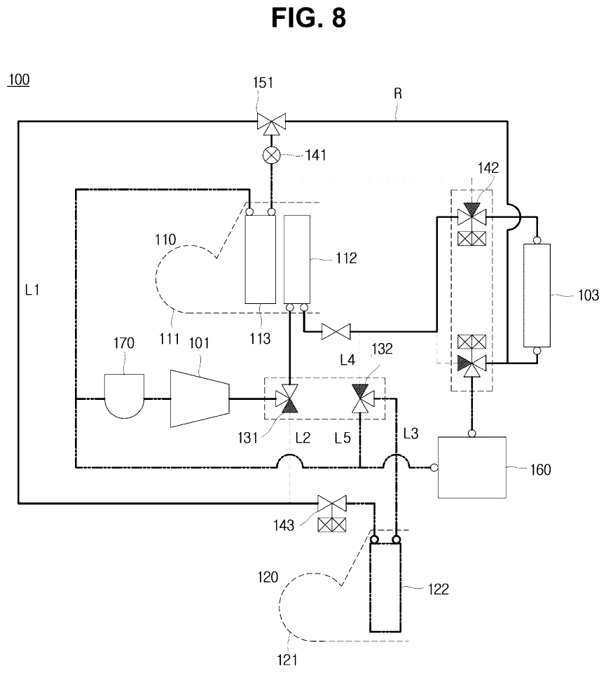

FIG. 8 is a block diagram showing a case in which the cooling mode is implemented using both the first air-conditioning apparatus and the second air-conditioning apparatus. Hereinafter, embodiment 6 will be described with reference to FIG. 8.

In order to implement the cooling mode according to embodiment 6 using both the first air-conditioning apparatus 110 and the second air-conditioning apparatus 120, opening/closing of the first three-way valve 131 is controlled such that the refrigerant that has passed through the compressor 101 flows to the indoor heat exchanger 112 of the first air-conditioning apparatus 110. In addition, opening/closing of the directional control valve 151 is controlled such that the refrigerant that has passed through the outdoor heat exchanger 103 flows to both the evaporator 113 of the first air-conditioning apparatus 110 and the dual-purpose heat exchanger 122 of the second air-conditioning apparatus 120.

A flow direction of the high-temperature and high-pressure refrigerant discharged from the compressor 101 is determined by the first three-way valve 131 such that the refrigerant flows to the first air-conditioning apparatus 110. Thereafter, the refrigerant that has passed through the indoor heat exchanger 112 of the first air-conditioning apparatus 110 flows to the second expansion valve 142 along the refrigerant circulation line R. In this case, the second three-way valve 132 mounted on the third refrigerant line L3 is controlled such that the outlet thereof connected to the refrigerant circulation line R is closed, thereby preventing backflow of the refrigerant. Thereafter, the refrigerant flows to the outdoor heat exchanger 103 or to the chiller 160.

The high-temperature and high-pressure refrigerant reaching the outdoor heat exchanger 103 is condensed and cooled in the outdoor heat exchanger 103. The condensed and cooled refrigerant flows along the refrigerant circulation line R and passes through the directional control valve 151. In this case, opening/closing of the directional control valve 151 is controlled such that the refrigerant flows to both the evaporator 113 of the first air-conditioning apparatus 110 and the dual-purpose heat exchanger 122 of the second air-conditioning apparatus 120. Accordingly, the refrigerant flows to both the first air-conditioning apparatus 110 and the second air-conditioning apparatus 120.

The refrigerant flowing toward the first air-conditioning apparatus 110 from the directional control valve 151 is throttled while passing through the expansion valve 141 and is then evaporated in the evaporator 113.

The refrigerant flowing toward the second air-conditioning apparatus 120 from the directional control valve 151 along the first refrigerant line L1 is throttled while passing through the third expansion valve 143 and is then evaporated in the dual-purpose heat exchanger 122. The low-temperature refrigerant cooled while passing through the dual-purpose heat exchanger 122 passes through the second three-way valve 132. As described above, the outlet of the second three-way valve 132 that is connected to the refrigerant circulation line R is in a closed state. Accordingly, the second three-way valve 132 allows the refrigerant to flow to the refrigerant circulation line R connecting the chiller 160 to the compressor 101. The refrigerant reaching the refrigerant circulation line R flows toward the compressor 101.

The refrigerant reaching the chiller 160 is used to cool the battery. The refrigerant flowing toward the compressor 101 is mixed with the refrigerant discharged from the evaporator 113 of the first air-conditioning apparatus 110. The mixed refrigerant flows to the compressor 101 via the accumulator 170.

According to embodiments 4 to 6 described above, the first air-conditioning apparatus 110 or the second air-conditioning apparatus 120 may perform the cooling function independently, or the first air-conditioning apparatus 110 and the second air-conditioning apparatus 120 may perform the cooling function simultaneously.

In the vehicular heat pump system 100 according to the embodiment of the present disclosure, a single dual-purpose heat exchanger 122 is employed in the second air-conditioning apparatus 120, thereby performing both heating and cooling functions, thereby minimizing a volume of the second air-conditioning apparatus 120. In addition, since an additional heat exchanger is not required in the second air-conditioning apparatus 120, a flow direction of refrigerant may be simplified, and accordingly, the number of piping components may be minimized.

As is apparent from the above description, according to the embodiment of the present disclosure, since the second air-conditioning apparatus is capable of performing both heating and cooling functions using a single dual-purpose heat exchanger, a volume of the second air-conditioning apparatus may be minimized. In addition, since an additional heat exchanger for performing a heating function does not need to be mounted in the second air-conditioning apparatus, a refrigerant flow may be simplified, and accordingly, addition of components, for example, piping components, may be minimized.

The above is only one embodiment for implementing the vehicular heat pump system according to the disclosure, the disclosure is not limited to the above embodiment, and it is to be understood by those skilled in the art that various modifications can be made without departing from the gist of the disclosure as claimed in the following claims.

What is claimed is:

1. A vehicular heat pump system comprising:
a compressor configured to compress refrigerant;
a first air-conditioning apparatus comprising an indoor heat exchanger and an evaporator, the indoor heat exchanger and the evaporator being configured to enable heat exchange of refrigerant discharged from the compressor;
a second air-conditioning apparatus comprising a dual-purpose heat exchanger configured to enable heat exchange of refrigerant delivered from the first air-conditioning apparatus; and
an outdoor heat exchanger configured to enable heat exchange between refrigerant and outdoor air,
wherein the second air-conditioning apparatus is configured to perform both heating and cooling functions using the dual-purpose heat exchanger.

2. The vehicular heat pump system as claimed in claim 1, wherein the dual-purpose heat exchanger is configured to evaporate refrigerant in a cooling mode and to condense refrigerant in a heating mode.

3. The vehicular heat pump system as claimed in claim 2, wherein the first air-conditioning apparatus further comprises a first air-conditioning case accommodating the indoor heat exchanger and the evaporator,
wherein the second air-conditioning apparatus is separately provided from the first air-conditioning apparatus and further comprises a second air-conditioning case accommodating the dual-purpose heat exchanger,
wherein the compressor, the first air-conditioning apparatus, and the outdoor heat exchanger are connected to one another via a refrigerant circulation line,
wherein the second air-conditioning apparatus is connected to the vehicular heat pump system via at least one refrigerant line, and
wherein the vehicular heat pump system further comprises a first expansion valve mounted on a refrigerant circulation line extending from an outlet of the outdoor heat exchanger to the evaporator of the first air-conditioning apparatus at a location upstream of the evaporator, the first expansion valve being configured to expand refrigerant flowing toward the first air-conditioning apparatus.

4. The vehicular heat pump system as claimed in claim 3, further comprising:
a directional control valve mounted upstream of the first expansion valve; and
a first refrigerant line extending from the directional control valve to the dual-purpose heat exchanger of the second air-conditioning apparatus.

5. The vehicular heat pump system as claimed in claim 4, further comprising:
a second refrigerant line branching from a predetermined branch point of a refrigerant circulation line extending from the compressor to the indoor heat exchanger and merging with the first refrigerant line; and
a first three-way valve provided at the branch point.

6. The vehicular heat pump system as claimed in claim 5, wherein the first three-way valve comprises an inlet connected to the compressor and two outlets connected in parallel to the indoor heat exchanger of the first air-conditioning apparatus and the dual-purpose heat exchanger of the second air-conditioning apparatus, and
wherein the first three-way valve switches a flow direction of refrigerant having passed through the compressor toward the indoor heat exchanger of the first air-conditioning apparatus or the dual-purpose heat exchanger of the second air-conditioning apparatus.

7. The vehicular heat pump system as claimed in claim 6, wherein refrigerant having passed through the first three-way valve flows to the indoor heat exchanger along the refrigerant circulation line, flows to the dual-purpose heat exchanger of the second air-conditioning apparatus via the second refrigerant line and the first refrigerant line, or flows to both the indoor heat exchanger and the dual-purpose heat exchanger, and
wherein the vehicular heat pump system further comprises a second expansion valve mounted on a refrigerant circulation line connected to an inlet of the outdoor heat exchanger, the second expansion valve being configured to expand or pass refrigerant to be supplied to the outdoor heat exchanger.

8. The vehicular heat pump system as claimed in claim 5, further comprising:
a third refrigerant line extending from the dual-purpose heat exchanger and merging with a refrigerant circulation line between the indoor heat exchanger and the outdoor heat exchanger;
a second three-way valve mounted on the third refrigerant line, the second three-way valve being configured to switch a flow direction of refrigerant flowing along the third refrigerant line; and
a chiller configured to receive refrigerant flowing along the refrigerant circulation line and to allow the refrigerant to exchange heat with a battery or an electric part.

9. The vehicular heat pump system as claimed in claim 8, wherein the second three-way valve allows refrigerant having passed through the dual-purpose heat exchanger to flow to a refrigerant circulation line between the indoor heat exchanger and the outdoor heat exchanger so as to be mixed with refrigerant having passed through the indoor heat exchanger or to flow to a refrigerant circulation line connecting the chiller to the compressor so as to be introduced into the compressor, and
wherein the vehicular heat pump system further comprises a third expansion valve mounted on the first refrigerant line.

10. The vehicular heat pump system as claimed in claim 5, wherein, in a heating mode, opening/closing of the first three-way valve is controlled to allow refrigerant having passed through the compressor to flow to the indoor heat exchanger of the first air-conditioning apparatus, and
wherein high-temperature and high-pressure refrigerant discharged from the compressor is condensed through heat exchange with indoor air of a vehicle while passing through the indoor heat exchanger of the first air-conditioning apparatus, and the condensed refrigerant is expanded in a second expansion valve, flows to the outdoor heat exchanger or to a chiller, absorbs heat in the outdoor heat exchanger or the chiller, and flows to the compressor via an accumulator.

11. The vehicular heat pump system as claimed in claim 5, wherein, in a heating mode, opening/closing of the first three-way valve is controlled to allow refrigerant having passed through the compressor to flow to the dual-purpose heat exchanger of the second air-conditioning apparatus, and
wherein high-temperature and high-pressure refrigerant discharged from the compressor is condensed through heat exchange with indoor air of a vehicle while passing through the dual-purpose heat exchanger of the second air-conditioning apparatus, and the condensed refrigerant is expanded in a second expansion valve via a second three-way valve, flows to the outdoor heat exchanger or to a chiller, absorbs heat in the outdoor heat exchanger or the chiller, and flows to the compressor via an accumulator.

12. The vehicular heat pump system as claimed in claim 5, wherein, in a heating mode, opening/closing of the first three-way valve is controlled to allow refrigerant having passed through the compressor to flow to both the indoor heat exchanger of the first air-conditioning apparatus and the dual-purpose heat exchanger of the second air-conditioning apparatus,
wherein high-temperature and high-pressure refrigerant discharged from the compressor diverges from the first three-way valve to the indoor heat exchanger of the first air-conditioning apparatus and to the dual-purpose heat exchanger of the second air-conditioning apparatus so as to be condensed through heat exchange with indoor air of a vehicle,
wherein the refrigerant condensed in the dual-purpose heat exchanger flows into a refrigerant circulation line via a second three-way valve, and is mixed with refrigerant flowing out of the indoor heat exchanger, and
wherein the refrigerant condensed in the indoor heat exchanger and the refrigerant condensed in the dual-purpose heat exchanger are expanded in a second expansion valve, flow to the outdoor heat exchanger or to a chiller, absorb heat in the outdoor heat exchanger or the chiller, and flow to the compressor via an accumulator.

13. The vehicular heat pump system as claimed in claim 5, wherein, in a cooling mode, opening/closing of the first three-way valve is controlled to allow refrigerant having passed through the compressor to flow to the indoor heat exchanger of the first air-conditioning apparatus, and opening/closing of the directional control valve is controlled to allow refrigerant having passed through the outdoor heat exchanger to flow to the evaporator of the first air-conditioning apparatus.

14. The vehicular heat pump system as claimed in claim 13, wherein high-temperature and high-pressure refrigerant discharged from the compressor passes through the indoor heat exchanger of the first air-conditioning apparatus and a second expansion valve via the first three-way valve, and flows to the outdoor heat exchanger,
wherein the high-temperature and high-pressure refrigerant is cooled and condensed in the outdoor heat exchanger and flows to a chiller, or is introduced into the evaporator of the first air-conditioning apparatus via the directional control valve and is evaporated in the evaporator, and
wherein refrigerant reaching the chiller and refrigerant discharged from the evaporator are mixed and flow to the compressor via an accumulator.

15. The vehicular heat pump system as claimed in claim 5, wherein, in a cooling mode, opening/closing of the first three-way valve is controlled to allow refrigerant having passed through the compressor to flow to the indoor heat exchanger of the first air-conditioning apparatus, and opening/closing of the directional control valve is controlled to allow refrigerant having passed through the outdoor heat exchanger to flow to the dual-purpose heat exchanger of the second air-conditioning apparatus.

16. The vehicular heat pump system as claimed in claim 15, wherein high-temperature and high-pressure refrigerant discharged from the compressor passes through the indoor heat exchanger of the first air-conditioning apparatus and a second expansion valve via the first three-way valve, and flows to the outdoor heat exchanger,
wherein the high-temperature and high-pressure refrigerant is cooled and condensed in the outdoor heat exchanger and flows to a chiller, or flows to the second air-conditioning apparatus via the directional control valve and is evaporated in the dual-purpose heat exchanger,
wherein the evaporated low-temperature refrigerant passes through a second three-way valve, and
wherein the second three-way valve allows the low-temperature refrigerant to flow to a refrigerant circulation line connecting the chiller to the compressor, and the low-temperature refrigerant reaching the refrigerant circulation line and refrigerant flowing out of the chiller are mixed and introduced into the compressor.

17. The vehicular heat pump system as claimed in claim 16, wherein the refrigerant reaching the chiller is used to cool a battery or an electric part, and
wherein refrigerant flowing from the chiller toward the compressor and refrigerant discharged from the dual-purpose heat exchanger are mixed and flow to the compressor via an accumulator.

18. The vehicular heat pump system as claimed in claim 5, wherein, in a cooling mode, opening/closing of the first three-way valve is controlled to allow refrigerant having passed through the compressor to flow to the indoor heat exchanger of the first air-conditioning apparatus, and opening/closing of the directional control valve is controlled to allow refrigerant having passed through the outdoor heat exchanger to flow to both the evaporator of the first air-conditioning apparatus and the dual-purpose heat exchanger of the second air-conditioning apparatus.

19. The vehicular heat pump system as claimed in claim 18, wherein high-temperature and high-pressure refrigerant discharged from the compressor passes through the indoor heat exchanger of the first air-conditioning apparatus and a second expansion valve via the first three-way valve, and flows to the outdoor heat exchanger,
wherein the high-temperature and high-pressure refrigerant is cooled and condensed in the outdoor heat exchanger and flows to a chiller, or flows to both the first air-conditioning apparatus and the second air-conditioning apparatus via the directional control valve,
wherein the refrigerant flowing toward the first air-conditioning apparatus is throttled while passing through the expansion valve, and is evaporated in the evaporator,
wherein the refrigerant flowing toward the second air-conditioning apparatus passes through the first refrigerant line, is throttled while passing through the expansion valve, and is evaporated in the dual-purpose heat exchanger,
wherein the evaporated low-temperature refrigerant passes through a second three-way valve, and
wherein the second three-way valve allows the low-temperature refrigerant to flow to a refrigerant circulation line connecting the chiller to the compressor, and the low-temperature refrigerant reaching the refrigerant circulation line and refrigerant flowing out of the chiller are mixed and introduced into the compressor.

20. The vehicular heat pump system as claimed in claim 19, wherein the refrigerant reaching the chiller is used to cool a battery or an electric part, and
wherein refrigerant flowing from the chiller toward the compressor and refrigerant discharged from the dual-purpose heat exchanger are mixed and flow to the compressor via an accumulator.
